(19) United States
(12) Patent Application Publication
(10) Pub. No.: US 2025/0217708 A1
(43) Pub. Date: Jul. 3, 2025

(54) Wrapper for Machine-Learned Model for Interactive Input Acquisition

(71) Applicant: Google LLC, Mountain View, CA (US)

(72) Inventors: Patricia Leigh MacWilliams, London (GB); Abhijit Guha Roy, London (GB); Jan Freyberg, London (GB); Terry Spitz, London (GB); Umesh Ramesh Telang, London (GB); DJ Dvijotham, Mountain View, CA (US)

(21) Appl. No.: 19/000,011

(22) Filed: Dec. 23, 2024

Related U.S. Application Data
(60) Provisional application No. 63/616,411, filed on Dec. 29, 2023.

(51) Int. Cl. G06N 20/00

(52) U.S. Cl. CPC G06N 20/00

(57) ABSTRACT

Systems and methods are provided for wrapping a machine-learned model to facilitate interactive input acquisition. One or more computing devices can obtain a machine-learned model configured to generate a prediction based at least in part on input feature data. The computing device(s) can obtain a first input value for a first input feature of the first machine-learned model. Based at least in part on the first input value, the computing device(s) can determine an estimated value of obtaining at least one additional input value for a second input feature of the first machine-learned model. Based on the estimated value, the computing device(s) can determine whether to obtain the at least one additional input value. Using the first machine-learned model, the computing device(s) can determine a prediction based at least on the first input value.

### CROSS-REFERENCE TO RELATED APPLICATIONS

The present application is based upon and claims the right of priority to U.S. Provisional Patent Application No. 63/616,411, filed on Dec. 29, 2023, the disclosure of which (including any appendices) is hereby incorporated by reference herein in its entirety for all purposes.

### FIELD

The present disclosure relates generally to machine learning processes and machine-learned devices and systems. More particularly, the present disclosure relates to systems and methods for interactively acquiring input (e.g., from a user) for a machine-learned model based on an estimated informational value of one or more additional inputs.

### BACKGROUND

Machine learning tasks can include, for example, (1) training a machine-learned model and (2) using a trained machine-learned model to perform inference. Performing inference can include obtaining input data, inputting the data to a machine-learned model, and generating an output based on the input data using the machine-learned model.

In some instances, machine-learned models, along with systems and methods for obtaining input data for machine-learned models, can be configured to process a fixed quantity and type of input data for every inference task. In some instances, a machine-learned model configured to process larger amounts of input data can be associated with improved performance (e.g., inference accuracy) relative to a machine-learned model configured to process less input data. However, in other instances, additional input data may have little impact on model performance. Thus, a tradeoff between a cost and benefit of obtaining additional data can vary for different use cases (e.g., varying data costs, varying importance of accurate inference, varying impact of particular datapoints on inference accuracy, etc.).

Due to varying costs and benefits of obtaining additional data, systems and methods requiring a fixed quantity and type of input data can in some instances require the collection of too much data, such as high-cost data having little impact on model accuracy in a particular case. In other instances, fixed-quantity systems and methods may process too little data, potentially ignoring low-cost input data that could advantageously improve a performance of a machine-learned model.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include obtaining, by one or more computing devices, a first machine-learned model configured to generate a prediction based at least in part on input feature data. The example method can include obtaining, by the one or more computing devices, a first input value for a first input feature of the first machine-learned model. The example method can include determining, by the one or more computing devices based at least in part on the first input value, an estimated value of obtaining at least one additional input value for a second input feature of the first machine-learned model. The example method can include determining, by the one or more computing devices based on the estimated value, whether to obtain the at least one additional input value. The example method can include determining, by the one or more computing devices using the first machine-learned model, the prediction based at least on the first input value.

The example method can include obtaining, by the one or more computing devices, the at least one additional input value. In the example method, the classification output can be determined based at least on the first input value and the at least one additional input value.

In the example method, determining, by the one or more computing devices based at least in part on the first input value, the estimated value of obtaining at least one additional input value for the second input feature of the first machine-learned model can include determining, by the one or more computing devices based at least in part on the first input value, a plurality of estimated values of obtaining at least one additional input value respectively for a plurality of different input features of the first machine-learned model. The example method can include selecting, by the one or more computing devices, a selected input feature of the plurality of different input features based on the plurality of estimated values. The example method can include obtaining, by the one or more computing devices, the at least one additional input value for the selected input feature. In the example method, the classification output can be determined based at least on the first input value and the at least one additional input value for the selected input feature.

In the example method, the at least one additional input value can include image data.

In the example method, the at least one additional input value can include non-image data.

In the example method, determining an estimated value can include obtaining, by the one or more computing devices, a plurality of possible additional input values for the second input feature. Determining an estimated value can include determining, by the one or more computing devices using the first machine-learned model, a plurality of respective predictions based on the first input value and based respectively on the plurality of possible additional input values. Determining an estimated value can include determining, based on the plurality of respective predictions, an estimated value of obtaining the at least one additional input value for the second input feature of the first machine-learned model. In the example method, a respective prediction can include a plurality of probabilities.

In the example method, the second input feature can include a categorical input feature, and the plurality of possible additional input values can include possible categories of the second input feature.

In the example method, the second input feature can include a numerical input feature, and obtaining the plurality of possible additional input values can include obtaining a distribution of numerical values associated with the second input feature. Obtaining the plurality of possible additional input values can include determining, based on the distribution of numerical values, a plurality of possible additional input values.

In the example method, determining an estimated value can include determining, using a second machine-learned model and based at least on the first input value, an estimated value of obtaining the at least one additional input value for the second input feature of the first machine-learned model.

In the example method, the second machine-learned model can be a model that was trained using one or more outputs of the first machine-learned model.

In the example method, the second machine-learned model can be a model that was trained by obtaining a plurality of sequence sets comprising two or more sequences per sequence set; generating, using the first machine-learned model, one or more first outputs based at least in part on a first subset of a respective sequence set of the plurality of sequence sets; generating, using the first machine-learned model, one or more second outputs based at least in part on a second subset of the respective sequence set of the plurality of sequence sets, wherein the second subset comprises the first subset and at least one additional sequence; and updating a second machine-learned model based on a comparison between the one or more first outputs and the one or more second outputs.

In the example method, the plurality of sequence sets can include a plurality of image sets.

In the example method, the at least one additional input value can include image data having an image type.

In the example method, the image type can be associated with one or more human-readable instructions for obtaining an additional image.

The example method can include obtaining, by the one or more computing devices, an information gain threshold associated with the second input feature

In the example method, the estimated value can be based at least in part on the information gain threshold.

The example method can include obtaining, by the one or more computing devices, a data collection burden associated with the second input feature. The example method can include obtaining, by the one or more computing devices, a threshold indicative of a ratio of data collection burden to information gain. The example method can include determining, by the one or more computing devices, an estimated information gain associated with the second input feature. In the example method, the estimated value can be based at least in part on the estimated information gain, the data collection burden, and the threshold.

In the example method, determining the estimated information gain can include determining a divergence metric between an output of the first machine-learned model generated without the at least one additional input value, and an output of the first machine-learned model generated using a possible additional input value associated with the second input feature.

In the example method, the divergence metric can include at least one of a Kullback-Leibler divergence, a Jensen-Shannon divergence, and an absolute difference in predictive entropy.

In the example method, the first machine-learned model can be a multimodal model configured for classification based in part on image data and based in part on non-image data.

In the example method, the first machine-learned model can be a multimodal fusion model having a classifier head.

In the example method, the classifier head can be a multilayer perceptron.

In the example method, the first machine-learned model can be configured to be agnostic to a number of images used as input to the first machine-learned model.

In the example method, the first machine-learned model can be configured to receive, as input, a pooled value associated with a plurality of image embeddings.

In the example method, the prediction can include one or more medical diagnoses.

Example aspects of the present disclosure provide an additional example method. In some implementations, the example method can include obtaining, by one or more computing devices, a plurality of sequence sets comprising two or more sequences per sequence set. The example method can include generating, by the one or more computing devices using a first machine-learned model configured to generate a prediction based at least in part on sequence data, one or more first predictions based at least in part on a first subset of a respective sequence set of the plurality of sequence sets. The example method can include generating, by the one or more computing devices using the first machine-learned model, one or more second predictions based at least in part on a second subset of the respective sequence set of the plurality of sequence sets. In the example method, the second subset can include the first subset and at least one additional sequence. The example method can include updating a second machine-learned model based on a comparison between the one or more first predictions and the one or more second predictions.

In the example method, the plurality of sequence sets can include a plurality of image sets.

In the example method, a first prediction can include a plurality of class probabilities.

In the example method, the second machine-learned model can be a statistical regression model.

In the example method, the second machine-learned model can be a random forest regressor.

In the example method, the at least one additional sequence can be image data characterized by an image type. In the example method, the image type can be associated with one or more human-readable instructions for obtaining an additional image.

Example aspects of the present disclosure provide one or more example non-transitory computer-readable media storing instructions that are executable by one or more processors to cause a computing system to perform example operations. In some implementations, the example operations can include obtaining, by one or more computing devices, a first machine-learned model configured to generate a prediction based at least in part on input feature data. The example operations can include obtaining, by the one or more computing devices, a first input value for a first input feature of the first machine-learned model. The example operations can include determining, by the one or more computing devices based at least in part on the first input value, an estimated value of obtaining at least one additional input value for a second input feature of the first machine-learned model. The example operations can include determining, by the one or more computing devices based on the estimated value, whether to obtain the at least one additional input value. The example operations can include determining, by the one or more computing devices using the first machine-learned model, the prediction based at least on the first input value.

Example aspects of the present disclosure provide an example computing system that includes one or more processors and one or more example non-transitory computer-readable media storing instructions that are executable by one or more processors to cause a computing system to perform example operations. In some implementations, the example operations can include obtaining, by one or more computing devices, a first machine-learned model configured to generate a prediction based at least in part on input feature data. The example operations can include obtaining, by the one or more computing devices, a first input value for a first input feature of the first machine-learned model. The example operations can include determining, by the one or more computing devices based at least in part on the first input value, an estimated value of obtaining at least one additional input value for a second input feature of the first machine-learned model. The example operations can include determining, by the one or more computing devices based on the estimated value, whether to obtain the at least one additional input value. The example operations can include determining, by the one or more computing devices using the first machine-learned model, the prediction based at least on the first input value.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example system according to example implementations of the present disclosure.

FIG. 2 is a block diagram of an example system according to example implementations of the present disclosure.

FIG. 3 is a flowchart diagram of an example method according to example implementations of the present disclosure.

FIG. 4 is a flowchart diagram of an example method according to example implementations of the present disclosure.

FIG. 5 is a flow chart diagram illustrating an example method for training a machine-learned model according to example implementations of aspects of the present disclosure;

FIG. 6 is a block diagram of an example processing flow for using machine-learned model(s) to process input(s) to generate output(s) according to example implementations of aspects of the present disclosure;

FIG. 7 is a block diagram of an example model development platform according to example implementations of aspects of the present disclosure;

FIG. 8 is a block diagram of an example training workflow for training a machine-learned model according to example implementations of aspects of the present disclosure;

FIG. 9 is a block diagram of an inference system for operating one or more machine-learned model(s) to perform inference according to example implementations of aspects of the present disclosure;

FIG. 10 is a block diagram of an example networked computing system according to example implementations of aspects of the present disclosure;

FIG. 11 is a block diagram of an example computing device according to example implementations of aspects of the present disclosure; and

FIG. 12 is a block diagram of an example computing device according to example implementations of aspects of the present disclosure.

### DETAILED DESCRIPTION

Generally, the present disclosure is directed to systems and methods for interactively acquiring input (e.g., from a user) for a machine-learned model (e.g., a multi-image multi-modal classification model) based on an estimated informational value of one or more additional inputs. A first input (e.g., input image) can be obtained. Based on the first input, a computing system can determine one or more estimated informational gains associated with acquiring one or more additional inputs. Based on the estimated informational gains, the computing system can determine whether to acquire any additional inputs (e.g., by requesting additional input from a user), and which additional inputs to acquire first. Advantageously, the provided systems and methods can act as a wrapper for a pre-existing machine-learned classification model, enabling interactive input acquisition without retraining the model.

In some instances, determining an estimated informational gain of obtaining an additional input can include providing a plurality of dummy inputs to the machine-learned model. For example, the machine-learned model can generate a first prediction (e.g., classification output) based solely on a first input (e.g., input image). The machine-learned model can generate a second prediction based on the first input and a first dummy input value associated with a particular input feature of the machine-learned model (e.g., age, blood pressure, first image input feature, second image input feature, etc.). The first and second predictions can each comprise, for example, a plurality of probabilities (e.g., class probabilities). Based on a comparison between the first prediction and the second prediction, a computing system can determine a first information gain associated with obtaining an additional input value corresponding to the first dummy input value. The same process can be repeated for a second dummy input value, third dummy input value, and so on, for a particular input feature (e.g., age, blood pressure, etc.). Based on the first information gain, second information gain, and so on, a computing system can determine an overall estimated information gain associated with acquiring an input of a particular type (e.g., by averaging the first, second, and third information gains, etc.). Determining an overall estimated information gain can include, for example, averaging, weighted averaging, or other appropriate method. As an illustrative example, if a first, second, and third dummy input value corresponded to ages of 25, 45, and 65, then a first, second, and third information gain might represent how much the machine-learned model's classification output would be expected to change after learning that a subject's age is 25, 45, or 65 respectively. An overall estimated information gain might represent how much the machine-learned model's classification output would be expected to change after learning a subject's age, wherein the subject's age is unknown beforehand.

In some instances, an additional input type can be associated with numerical input values (e.g., age, blood pressure, etc.). In such instances, a plurality of dummy inputs can be determined based on a distribution (e.g., population distribution, expected distribution based on inputs gathered so far, etc.) of input values associated with the input type. As an illustrative example, a plurality of dummy inputs can include a 10th percentile input value, median input value, and 90th percentile input value associated with a distribution of possible input values. It will be appreciated that other configurations are possible.

In other instances, an additional input type can be associated with categorical input data (e.g., yes/no/unknown, inpatient/outpatient, etc.). In such instances, a plurality of dummy inputs can include every possible category associated with the additional input type. Determining an overall estimated information gain can include, for example, an average or weighted average. In some instances, one or more weights of a weighted average can correspond to a probability of an additional input belonging to a particular category. As an illustrative example, if 17 percent of a patient population is expected to answer “yes” to a “yes/no/unknown” categorical input, a weight associated with information gain from a “yes” input can be 0.17.

In some instances, determining an estimated informational gain of obtaining an additional input can include using a second machine-learned model that has been trained to estimate, based on one or more already-existing inputs and an additional input type, an expected information gain associated with a first machine-learned classification model. In some instances, an additional input type can be a type of image input (e.g., close-up image, far-away image, MRI image, X-ray image, etc.).

Training the second machine-learned model can include, for example, obtaining a training dataset comprising a plurality of training instances. Each training instance can include a plurality of training inputs. In some instances, a training instance can include a ground truth output. Training the second machine-learned model can include, for example, obtaining a subset of a respective plurality of training inputs associated with a respective training instance. The first machine-learned model can generate a first classification output (e.g., a plurality of class probabilities) based on the subset of inputs. The first machine-learned model can generate a second classification output based on the subset of inputs and an additional input (e.g., additional input image) associated with the respective training instance, wherein the additional input is not part of the subset of inputs. The additional input can have an additional input type (e.g., image type). A computing system can update the second machine-learned model based on one or more of the first classification output, the second classification output, the ground truth value, and an input type.

In some instances, determining whether to acquire additional input can include comparing one or more estimated information gains to one or more information gain thresholds. An information gain can include, for example, an expected performance improvement (e.g., improved precision, recall, area under precision-recall curve, etc.) of the first machine-learned model or an expected change (e.g., based on a divergence metric) to one or more outputs of the first machine-learned model. An information gain threshold can be set, for example, by an individual user (e.g., image subject, medical practitioner, etc.) without retraining or otherwise modifying the first machine-learned model or a second machine-learned model. In some instances, separate information gain thresholds can be set for separate data types (e.g., image data vs. metadata, separate image types, separate metadata types, etc.). Comparing an estimated information gain to an information gain threshold can include, for example, deciding not to acquire additional data of a particular type if an expected information gain is not larger than a corresponding information gain threshold.

Systems and methods of the present disclosure have various technical effects and benefits. For example, systems and methods of the present disclosure can in some instances reduce a number of inputs required to achieve a threshold classification accuracy for a given machine-learned classification model. In some example experiments according to the present disclosure, provided systems and methods reduced a number of image inputs used by 36.2 percent and reduced a number of non-image inputs used by 82 percent compared to prior systems and methods, while maintaining predictive performance. This reduction can reduce a data acquisition cost at inference time, by reducing or eliminating queries for irrelevant or redundant data.

Additionally, in some instances, machine-learned models associated with higher computational costs (e.g., due to larger numbers of parameters, etc.) can have a higher accuracy than machine-learned models having lower computational costs. It will therefore be appreciated that systems and methods of the present disclosure can in some instances enable a computing system to achieve a given accuracy using a lower-cost (e.g., lower computational cost of training, inference, etc.) machine-learned model than prior systems and methods.

Additionally, reducing a number of inputs can in some instances reduce a cost (e.g., computational cost, electricity cost, etc.) associated with additional data. For example, in some example experiments according to the present disclosure, provided systems achieved similar accuracy using fewer input images compared to prior systems. In some instances, collecting additional images (e.g., MRI images, CT scan images, etc.) can be associated with a high cost (e.g., computational cost, electricity cost, labor cost, etc.). Additionally, processing additional images using a machine-learned image classification model can in some instances be associated with a high computational cost (e.g., electricity cost, etc.). Thus, systems and methods of the present disclosure can improve the functioning of a computing system by reducing a computational cost of image-based classification by reducing a number of images required to be collected and processed.

Additionally, reducing a number of inputs needed to make an accurate classification can reduce a user dropout rate. For example, in some example experiments according to the present disclosure, a number of inputs required for provided systems to make an accurate classification was compared to a number of inputs required for prior systems to make an accurate classification. The numbers of required inputs were compared to a dataset of user dropout rates indicating what percentage of users are likely to drop out of a classification workflow at each input step. Based on this data, a simulated user drop-out rate was determined for provided systems and methods and for prior systems and methods. Provided systems and methods were associated with a lower simulated drop-out rate.

Additionally, reducing a user drop-out rate can increase a number of users who receive an accurate diagnosis. In the example drop-out rate simulations, an expected number of positive outcomes was also determined, wherein a positive outcome was defined as an accurate classification for a user who did not drop out. In these simulations, provided systems and methods were associated with a higher rate of simulated positive outcomes.

Provided systems and methods of the present disclosure also have the technical effect and benefit of being combinable with multiple machine-learned classification models without significant model retraining. Systems and methods of the present disclosure act as a wrapper which can operate on top of, e.g., any multi-modal/multi-view ML model and make it interactive. This can make provided systems and methods easy to use in a scalable manner, without retraining the underlying model. Therefore, systems and methods of the present disclosure can enable iterative improvement of an underlying machine-learned classification model without significant retraining costs for the provided wrappers. Additionally, systems and methods of the present disclosure can have the technical effect and benefit of allowing one or more information gain thresholds to be updated (e.g., based on individual preference, based on a change in input acquisition costs, etc.) with no retraining. Thus, provided systems and methods can in some instances enable system modifications at a reduced computational cost (e.g., energy cost) compared to prior systems and methods.

In other instances, systems and methods of the present disclosure can improve a classification accuracy for a given machine-learned classification model and a given number of permissible additional inputs. In some example experiments according to the present disclosure, provided systems and methods were compared to prior methods for selecting a subset of additional inputs to acquire. In the experiments, provided systems and methods achieved higher classification accuracy than prior systems and methods across a variety of additional input counts.

A technical effect of example implementations of the present disclosure is increased energy efficiency in performing operations using machine-learned models, thereby improving the functioning of computers implementing such models. For instance, example implementations can provide for more energy-efficient runtime execution or inference. In some scenarios, increased energy efficiency can provide for less energy to be used to perform a given task (e.g., less energy expended to maintain the model in memory, less energy expended to perform calculations within the model, etc.). In some scenarios, increased energy efficiency can provide for more task(s) to be completed for a given energy budget (e.g., a larger quantity of tasks, more complex tasks, the same task but with more accuracy or precision, etc.).

In another example aspect, example implementations can provide for more energy-efficient training operations or model updates. In some scenarios, increased energy efficiency can provide for less energy to be used to perform a given number of update iterations (e.g., less energy expended to maintain the model in memory, less energy expended to perform calculations within the model, such as computing gradients, backpropagating a loss, etc.). In some scenarios, increased energy efficiency can provide for more update iterations to be completed for a given energy budget (e.g., a larger quantity of iterations, etc.). In some scenarios, greater expressivity afforded by model architectures and training techniques of the present disclosure can provide for a given level of functionality to be obtained in fewer training iterations, thereby expending a smaller energy budget. In some scenarios, greater expressivity afforded by model architectures and training techniques of the present disclosure can provide for an extended level of functionality to be obtained in a given number of training iterations, thereby more efficiently using a given energy budget.

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

An example field of application for the present disclosure can be medical diagnosis, in which systems and methods of the present disclosure can make machine-learned models more compatible with existing clinical workflows. For example, although receiving a large number of multi-modal inputs can boost a model performance, acquiring all inputs for every case in a clinical workflow can often be challenging. It can take time to provide each piece of information, but not all information is relevant to a case. In some instances, extraneous questions may lead to unnecessary data collection costs or even incomplete input submissions, which can in some instances prevent a prior machine-learned model from performing inference at all. Advantageously, systems and methods of the present disclosure can be compatible with clinical workflows, being able to assess at any point whether a confident diagnosis can be provided or whether more information is needed. However, it will be appreciated that systems and methods of the present disclosure can be applied to various non-medical fields, including any field in which model accuracy can be useful and a cost or burden of acquiring additional input data can be greater than zero (e.g., machine-learned structural engineering assessments, anti-personnel landmine detection, sinkhole detection, etc.).

Additional example fields of application can include, for example, non-medical image-based classification such as landmine detection or subsurface void (e.g., sinkhole) detection (e.g., for use in assessing roadways). For example, in some instances, a first input may comprise image data, such as data from one or more imaging procedures (e.g., ground-penetrating radar scan, infrared thermography scan, etc.). In other instances, a first input may comprise non-image data (e.g., a time since a particular road was built, a geological property of a region in which a road is located, etc.). Based on the first input, a computing system can determine one or more estimated informational gains associated with acquiring one or more additional inputs (e.g., additional imaging scans, results of one or more tests, metadata associated with a particular subsurface region such as soil type, etc.). Based on the estimated informational gains, the computing system can determine whether to acquire any additional inputs and which additional inputs to acquire first (e.g., particular type of scan, such as higher- or lower-precision ground-penetrating radar, etc.). In some instances, the determination can depend on one or more costs associated with data collection (e.g., cost of high-precision scan, cost of lower-precision scan, etc.), which can be defined independently by each individual user. For example, in some instances a city that already owns a piece of imaging equipment (e.g., ground-penetrating radar) may have a different marginal cost of imaging compared to a city that must rent equipment or hire an imaging professional.

Additional example fields of application can include, for example, classification based at least in part on sequences other than images (e.g., text classification or short-form question answering associated with text sequences; classification of audio sequences such as music or speech; etc.). In some instances, sequence classification inputs can include multimodal sequence inputs (e.g., involving multiple types of sequence data such as audio and image, involving sequence data and non-sequence data, etc.). In some instances, a first input can be an input sequence (e.g. textual input context, image input, audio input, etc.). In other instances, a first input can be non-sequence data (e.g. metadata about an input or desired output, such as artist name, preferred style, desired sequence length, etc.). An output can include, for example, one or more classes or one or more class probabilities.

Additional example fields of application can include, for example, sequence generation (e.g., text generation, image generation, audio generation such as speech continuation or music continuation, etc.). For example, in some instances, a first input can be an input context (e.g., text sequence context, image context, audio, etc.). An output of the machine-learned model can be, for example, a generated sequence (e.g., text sequence, audio sequence, image, etc.). In some instances, an estimated information gain associated with an additional input can comprise, for example, an estimated divergence between a value generated using a machine-learned model without the additional input and a generated value or expected value associated with the machine-learned model and the additional input type. In some instances, a value generated can be an intermediate value such as a probability distribution configured to be used to generate one or more outputs (e.g., via temperature-based sampling, etc.).

Various example implementations are described herein with respect to the accompanying Figures.

### Example Systems

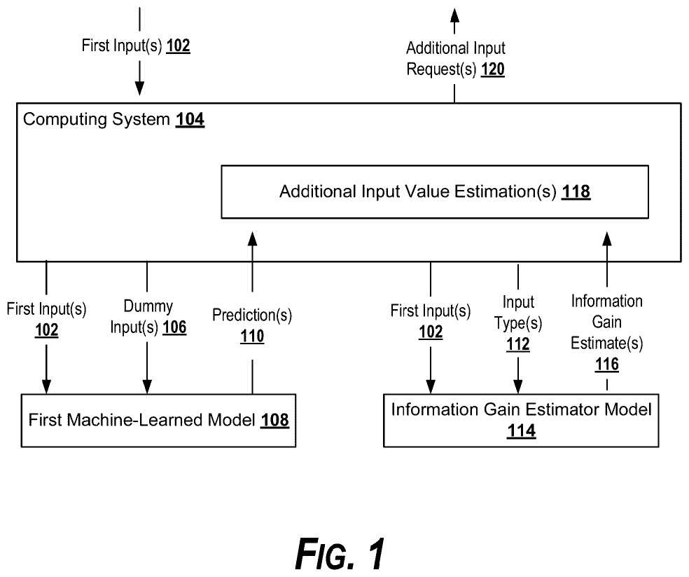

FIG. 1 is a block diagram of an example system according to example implementations of the present disclosure, in which a computing system 104 can determine whether to request one or more additional inputs for use by a first machine-learned model 108. A computing system 104 can obtain one or more first input(s) 102. The first input(s) 102 and one or more dummy inputs 106 can be input to a first machine-learned model 108, which can generate one or more predictions 110. The first input(s) 102 and one or more input types 112 can be input to an information gain estimator model 114, which can generate an information gain estimate 116 for each input type 112. Based on the predictions 110 and the information gain estimates 116, the computing system 104 can perform an additional input value estimation 118 to estimate a value of obtaining an additional input. If a value of obtaining an additional input is greater than zero, the computing system 104 can send one or more additional input requests 120 to a user or another computing system.

FIG. 1 depicts one or more first inputs 102. First input(s) 102 can generally include or otherwise represent various types of data. First input(s) 102 can include one type or many different types of data. In some instances, first input(s) 102 can include computer-readable data associated with one or more images (e.g., black-and-white or color image data; video or still image data; photographs, drawings, visual representations of non-visual data such as medical imaging data, etc.) Example data types can include compressed or uncompressed image data, binary or text-based image metadata, machine-learned semantic embeddings associated with an image, etc. First input(s) 102 can include non-image data. First input(s) 102 can include, for example, metadata associated with one or more images (e.g., image type, description, etc.) or subjects of one or more images (e.g. medical patient's age, medical history, blood pressure, etc.). Metadata associated with a subject of an image can include, for example, numerical data, categorical data, or other types of data (e.g., audio, text, machine-learned semantic embedding, etc.). In some instances, first input(s) 102 can include vector-based data (e.g., binary vector representing categorical data, concatenated vector of categorical and numerical data representing a plurality of metadata inputs, etc.).

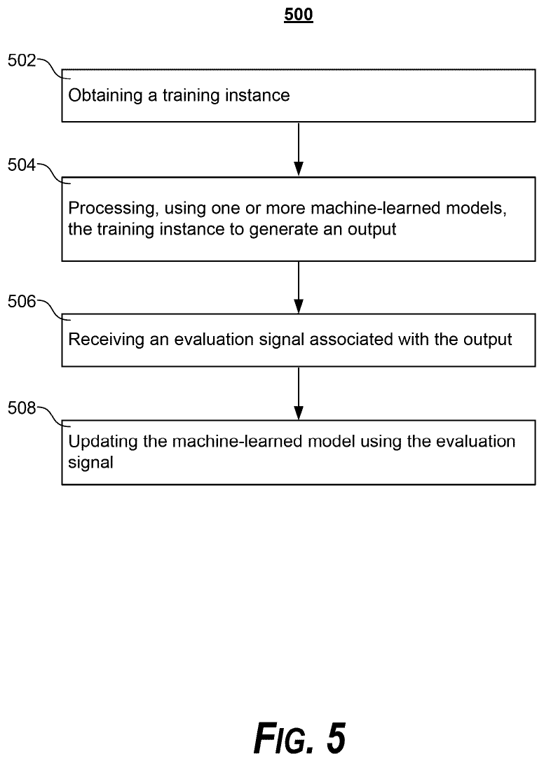

FIG. 1 depicts a computing system 104. The computing system 104 can include, for example, one or more computing devices. The computing system 104 can be located on a single computing system or distributed across multiple computing systems. In some instances, a computing system 104 can correspond to a computing system described with respect to FIGS. 5 through 12 (e.g., server computing system 60, etc.).

FIG. 1 depicts one or more dummy inputs 106. Dummy input(s) 106 can generally include or otherwise represent various types of data. Dummy input(s) 106 can include one type or many different types of data. Dummy input(s) 106 can be data of the same type(s) or of different types of data as compared to first input(s) 102. In some instances, for example, dummy inputs 106 can be, comprise, or share a data type with metadata associated with one or more first inputs 102 or subjects of one or more first inputs 102 (e.g., image subjects). In some instances, dummy inputs 106 can be categorical or numerical data associated with one or more first inputs 102 or subjects of one or more first inputs 102.

Generating one or more dummy inputs 106 can include, for example, identifying one or more possible input values associated with an input type. In some instances, dummy inputs 106 can comprise categorical data associated with a categorical input type having a finite number of categories. In such instances, generating dummy inputs 106 can include, for example, generating a dummy input 106 corresponding to every possible category of the categorical input type.

In some instances, generating dummy inputs 106 can comprise obtaining a distribution of input values associated with an input type (e.g., numerical input type such as age). In some instances, a distribution of input values can be a population distribution. A population distribution can include, for example, a distribution (e.g., age distribution, etc.) of a population or subpopulation. A population or subpopulation can be defined in various ways, such as geographically (e.g., a country's population), by demographic information (e.g., patients over a certain age), a shared characteristic (e.g., patients with high blood pressure, patients of a particular hospital), or any other definition. Although the word “population” is used here, it will be appreciated that systems and methods of the present disclosure can be applied to a population of non-human image subjects (e.g., machines, roofs, bridges, etc.) without going outside the scope of the present disclosure.

In some instances, a distribution of input values can be a machine-learned distribution of input values. For example, in some instances, a machine-learned model (e.g., first machine-learned model 108 or other machine-learned model) can be configured to generate an expected distribution of input values associated with an input type (e.g., an expected distribution of ages, etc.) based on one or more first inputs 102 (e.g., an input image, etc.).

In some instances, generating dummy inputs 106 can include selecting values from a distribution of input values. In some instances, values can be selected based on one or more percentiles of the distribution (e.g. 10^{th} percentile, 50^{th} percentile, 90^{th} percentile, etc.). It will be appreciated that other methods for selecting or generating dummy inputs 106 are possible (e.g., random sampling from a distribution, random sampling from a dataset of sample inputs, etc.).

FIG. 1 depicts a first machine-learned model 108. The first machine-learned model 108 can be or include various different types of machine-learned model architectures. The first machine-learned model 108 can be or include a model configured to generate one or more predictions (e.g., classifications, next-token predictions, etc.) based on one or more inputs (e.g., image inputs, other sequence inputs, numerical inputs, categorical inputs, etc.). In some instances, a prediction of the first machine-learned model 108 can be a classification output (e.g., plurality of class probabilities, top k most likely classes, etc.). In some instances, a prediction of the first machine-learned model 108 can include a plurality of probabilities (e.g., class probabilities, next-token probabilities, etc.). In some instances, the first machine-learned model 108 can be configured to generate one or more predictions based on a combination of image data and non-image data. In some instances, the first machine-learned model 108 can be configured to generate one or more predictions based on a single input image or multiple input images. In some instances, the first machine-learned model 108 can be a multi-view, multi-modal classifier model configured to output a classification based on zero or more (e.g., one or more) image inputs and zero or more non-image inputs. In some instances, the first machine-learned model 108 can be configured to be capable of taking an arbitrary number of images as input, such that the first machine-learned model 108 can be agnostic to a number of input images. For example, in some instances, a multi-image embedding of the first machine-learned model 108 can include a pooled value (e.g., average-pooled value) based on a plurality of single-image embeddings. In some instances, the first machine-learned model 108 can comprise an image embedding model and a metadata embedding, fusion, and classification model. However, it will be appreciated that other architectures are possible. In some instances, the first machine-learned model 108 can comprise a classifier head configured to receive one or more image embeddings (e.g., an average-pooled multi-image embedding) and one or more embeddings of non-image data as input. In some instances, a classifier head of the first machine-learned model 108 can be configured to output a plurality of class probabilities (e.g., based on a softmax function). In some instances, the first machine-learned model 108 can be configured to fuse one or more image embeddings with one or more embeddings of non-image data using a fusion strategy (e.g., feature-wise linear modulation, concatenation with case-level embedding, etc.) before passing the fused embeddings to a classifier head. In some instances, a classifier head of the first machine-learned model 108 can be a multi-layer perceptron.

FIG. 1 depicts one or more predictions 110. Predictions 110 can generally include or otherwise represent various types of data. Predictions 110 can include one type or many different types of data. In some instances, predictions 110 can be classification outputs. In some instances, classification outputs can include one or more classes (e.g., diagnosis, image classification, etc.) or one or more class probabilities (e.g., a plurality of class probabilities associated respectively with a plurality of classes). Predictions 110 can include data of the same type(s) or of different types of data as compared to input(s) 102, 106.

FIG. 1 depicts one or more input types 112. An input type 112 can be, for example, machine-readable data indicative of a type of input. In some instances, the type of input can include a type of sequence input. In some instances, a type of sequence input can include a type of image (e.g. closeup image, faraway image, MRI image, X-ray image, etc.). In some instances, an input type 112 can be associated with one or more human-readable or machine-readable instructions for generating an input such as an image (e.g., “Please provide a close-up shot of your skin condition”; “Lateral view X-ray required”; a machine-readable instruction to photograph or scan a particular subject at a particular resolution; etc.). An input type 112 can be represented, for example, by a variety of machine-readable data types (e.g., categorical, boolean or integer data; text data such as a type description; machine-learned semantic embedding; etc.). An input type 112 can include one type or many different types of data.

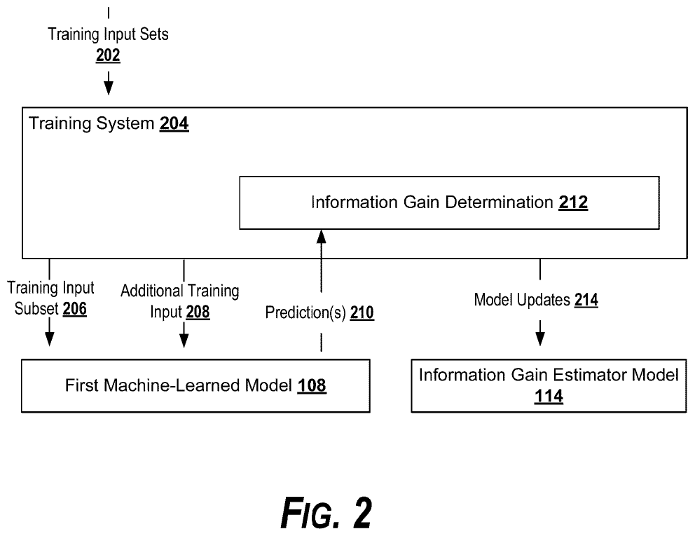

FIG. 1 depicts an information gain estimator model 114. The information gain estimator model 114 can be or include various different types of machine-learned model architectures. The information gain estimator model 114 can be or include a model configured to generate one or more numerical outputs (e.g., information gain estimates, etc.) based on one or more inputs (e.g., image inputs, numerical inputs, categorical inputs, etc.). In some instances, the information gain estimator model 114 can be or include a model configured to generate one or more outputs (e.g., information gain estimates 116, etc.) based on one or more first inputs 102 and one or more additional inputs indicative of an input type (e.g., one or more input types 112). In some instances, the information gain estimator 114 can be or include a supervised statistical model (e.g., random forest regressor, etc.). In some instances, the information gain estimator model 114 can be trained according to one or more systems or methods described below with respect to FIG. 2.

FIG. 1 depicts an information gain estimate 116. An information gain estimate 116 can generally include or otherwise represent various types of data. An information gain estimate 116 can include one type or many different types of data. In some instances, an information gain estimate 116 can include data (e.g., numerical data) indicative of an estimated information gain associated with adding an additional input to the first machine-learned model 108 of a particular input type (e.g., input type 112). An information gain estimate 116 can represent, for example, an expected improvement in a measure of model accuracy (e.g., precision, recall, area under a precision-recall curve, etc.) associated with acquiring an additional input (e.g., input image) or an expected divergence (e.g., Kullback-Leibler divergence, Jensen-Shannon divergence, absolute difference in predictive entropy, etc.) between a first classification output based on the first inputs 102 and a second classification output based on the first input(s) 102 and an additional input (e.g., additional input image having a particular input type 112).

FIG. 1 depicts one or more additional input value estimations 118. Performing an additional input value estimation can comprise, for example, generating one or more information gain estimates 116 associated with one or more dummy inputs 106 and corresponding predictions 110. For example, in some instances, an information gain estimate 116 can be generated by comparing a first prediction 110 based on the first input(s) 102 to one or more respective second predictions 110 based on the first input(s) 102 and one or more respective dummy inputs 106. For example, a divergence metric (e.g. Kullback-Leibler divergence, Jensen-Shannon divergence, absolute difference in predictive entropy, etc.) can be computed between a first prediction 110 and a respective second prediction 110 to determine an information gain estimate 116 associated with a respective dummy input 106. In some instances, a particular input type (e.g., age, blood pressure, etc.) can be associated with a plurality of respective dummy inputs 106. In such instances, an overall information gain estimate 116 associated with the input type can be determined based on a plurality of respective information gain estimates corresponding to the plurality of respective dummy inputs 106. For example, in some instances, a plurality of respective information gain estimates 116 associated with a same input type can be combined (e.g., by averaging, weighted averaging, etc.) to generate an overall information gain estimate 116 indicative of an expected information gain for acquiring an additional input of that type.

In some instances, performing an additional input value estimation can include, for example, comparing one or more information gain estimates 116 to one or more information gain thresholds. For example, in some instances a value of acquiring an additional input can correspond to a difference computed by subtracting an information gain threshold from a corresponding information gain estimate 116. In this manner, for instance, one or more additional input requests 120 can be generated if one or more information gain estimates 116 is greater than a corresponding information gain threshold. Conversely, if each information gain estimate 116 is smaller than a corresponding information gain threshold, then a prediction 110 based on the first input(s) 102 can be output (e.g., to a user, to another computing device, etc.) as a final classification output.

In some instances, an individual user (e.g., image subject, medical practitioner, etc.) can customize one or more information gain thresholds without requiring any retraining of the first machine-learned model 108 or information gain estimator model 114. In some instances, a plurality of information gain thresholds can correspond to a plurality of input types. In some instances, two or more input types can share an information gain threshold. For example, in some instances, a first information gain threshold can be used for a plurality of image-based input types (e.g. near-shot images, far-shot images, MRI images, etc.) and a second information gain threshold can be used for a plurality of non-image-based input types. In some instances, an information gain threshold can be determined based on one or more costs and benefits (e.g., cost of acquiring additional data of a particular type, cost of misclassification, benefit of improved classification performance, etc.). For example, in some instances, each respective input type can be associated with a cost of collection; in some instances, a user (e.g., patient, medical practitioner, etc.) can set an overall cost-to-benefit threshold indicative of a ratio between an information gain and a cost of collection. In some instances, a combined information gain threshold can be defined, which can correspond to a combined information gain required to request a plurality of additional inputs (e.g., via a questionnaire asking a plurality of additional questions, a medical imaging procedure generating a plurality of images, etc.).

In some instances, one or more information gain thresholds can be learned based on one or more objective functions. For example, in some instances, one or more information gain thresholds can comprise tunable hyperparameters. In some instances, a tunable hyperparameter can be tuned using a validation dataset, which can be split into a training subset and a tuning subset. In some instances, an objective can comprise a first component indicative of a total number of inputs acquired (including, e.g., the first input(s) 102 and any additional inputs acquired via additional input request(s) 120) and a second component indicative of a predictive performance (e.g. precision, recall, area under a precision-recall curve, loss function configured for classification, etc.). In some instances, an objective can comprise a combination (e.g., weighted combination) of the first component and second component. In some instances, an objective can be configured to optimize one of the first and second components, subject to a condition associated with the other of the first and second components (e.g., maximum predictive performance given a maximum number of permissible additional input request(s) 120, etc.). Learning an information gain threshold can comprise, for example, training an information gain estimator model 114 using a training subset of a split training dataset; performing a plurality of additional value estimations 118 based on a plurality of candidate information gain thresholds using a tuning subset of a split training dataset; and determining, based on the additional input value estimations 118 and a tuning objective, one or more preferred information gain thresholds.

FIG. 1 depicts one or more additional input requests 120. In some instances, an additional input request 120 can be or include human-readable data configured to acquire an additional input from a user (e.g., a question, an instruction to take an additional photograph, etc.). In some instances, a user can be, for example, a professional (e.g., medical professional) and an additional input request 120 can include prompting the user over a device (e.g., mobile device). A prompt can include, for example, a list of questions for the professional to ask (e.g., to a patient) or answer. In some instances, an additional input request 120 can be or include machine-readable data configured to cause a computing system to acquire additional input (e.g., by requesting input from a user, performing a measurement, generating an image, retrieving data from one or more non-transitory computer-readable media, etc.).

FIG. 2 is a block diagram of an example system according to example implementations of the present disclosure, in which an information gain estimator model 114 can be trained based on outputs from a first machine-learned model 108. A training system 204 can obtain one or more training input sets 202. From a training input set 202, the training system 204 can select a training input subset 206 and an additional training input 208 that belongs to the training input set 202 but not the training input subset 206. The training system 204 can input the training input subset 206 and additional training input 208 to a first machine-learned model 108, which can output a first prediction 210 based on the training input subset 206, and a second prediction 210 based on the training input subset 206 and the additional training input 208. Based on the predictions 210, the training system 204 can perform an information gain determination 212 to determine an amount of information gain associated with obtaining the additional training input 208 (compared to relying on the training input subset 206 alone). Based on the information gain determination 212, the training system 204 can perform a model update 214 on the information gain estimator model 114.

FIG. 2 depicts a plurality of training input sets 202. Each training input set 202 can include, for example, a plurality of training inputs associated with a single training instance. An input of a training input set 202 can generally include or otherwise represent various types of data. A training input set 202 can include one type or many different types of data. An input of a training input set 202 can be data of the same type(s) or of different types of data as compared to first input(s) 102 or dummy input(s) 106.

FIG. 2 depicts a training system 204. The training system 204 can be, for example, one or more computing systems configured to train one or more machine-learned models. The training system 204 can be located on a single computing system or distributed across multiple computing systems. In some instances, the training system 204 can be, comprise, be comprised by, implement, or be implemented by a computing system 104. In some instances, a training system 204 can correspond to a computing system described with respect to FIGS. 5 through 12 (e.g., server computing system 60, etc.).

FIG. 2 depicts a training input subset 206. A training input subset 206 can be, for example, a subset (e.g., a non-empty proper subset) of a training input set 202. A training input subset 206 can include one or more training inputs associated with a single training instance (e.g., a single diagnosis, a single patient, etc.). A training input of the training subset 206 can be, comprise, be identical or equivalent to, or have a same data type as an input of the training input set 202. In some instances, a training system 204 can select a training input subset 206 from a training input set 202 in any appropriate way (e.g., random selection, etc.). In some instances where a training input set 202 has n training inputs, any subset comprising (n−1) or fewer training inputs can be a training input subset 206. In some instances, a training system 204 can select one training input subset 206 or a plurality of training input subsets 206 from a same training input set 202.

FIG. 2 depicts an additional training input 208. An additional training input 208 can be, for example, a training input of a training input set 202 that is not included in a corresponding training input subset 206 of the training input set 202. An additional training input 208 can generally include or otherwise represent various types of data. An additional training input 208 can include one type or many different types of data. An additional training input 208 can be data of the same type(s) or of different types of data as compared to one or more inputs of a training input subset 206.

FIG. 2 depicts predictions 210. In some instances, predictions 210 can be, comprise, be comprised by, or have one or more properties (e.g., data types) that are the same as a prediction 110.

FIG. 2 depicts an information gain determination 212. An information gain determination 212 can be, for example, a determination of an amount of information gained by adding an additional training input 208 to a training input subset 206. An information gain determination 212 can comprise, for example, a comparison between a first prediction 210 based on a training input subset 206 and a second prediction 210 based on the training input subset 206 and a corresponding additional training input 208 associated with a same training instance. In some instances, an information gain can be determined based on the first prediction 210, the second prediction 210, and a ground-truth label associated with the training instance. In some instances, an information gain can be a change in predictive distance from the ground-truth label. For example, in some instances, if a second prediction 210 is closer than the first prediction 210 to the ground-truth label according to a measure of predictive distance, then an information gain associated with the additional training input 208 can be positive. If the second prediction 210 is further away, then the corresponding information gain can be negative. In some instances, a measure of predictive distance can include a Kullback-Leibler divergence, Jensen-Shannon divergence, or absolute change in predictive entropy. It will be appreciated that other predictive distance metrics are possible. In some instances, an information gain determination 212 can be performed without a ground truth label. For example, an information gain can in some instances comprise a distance metric (e.g., Kullback-Leibler divergence, etc.) between a first prediction 210 and a second prediction 210.

FIG. 2 depicts model updates 214. Performing a model update 214 can include, for example, modifying a current state (e.g., one or more respective current values of one or more parameters) of the information gain estimator model 114. In some instances, a model update 214 can be based on an information gain determination 212 and an input type (e.g., image type) associated with an additional training input 208. In some instances, a model update 214 can be further based on other data associated with a training input subset 206, additional training input 208, or one or more predictions 210 (e.g., number of images in a training input subset 206, number of images of the same type as the additional training input 208 in the training input subset 206, number or type of non-image metadata inputs in the training subset 206, softmax-based predictive confidence associated with a first prediction 210, etc.). In some instances, the model update 214 can be based on an objective function. In some instances, the model update 214 can comprise statistical regression (e.g., random forest regression). It will be appreciated that other configurations are possible. In some instances, performing a model update 214 can include performing one or more activities (e.g., gradient updates) discussed below with respect to FIG. 5.

### Example Results

In some example experiments according to the present disclosure, provided systems and methods were compared to provided systems and methods on a plurality of dermatology-based diagnostic tasks. A training dataset was obtained comprising a plurality of diagnostic cases comprising ground truth diagnoses from a plurality of board-certified dermatologists. Each ground truth diagnosis was paired with one or more images and one or more pieces of non-image metadata (e.g., medical history data, etc.) associated with the image subject. Images included near-shot images and far-shot images. The number of images captured and the type of images (near-shot/far-shot etc.) per case were decided by the respective clinicians who first treated the respective image subjects. The images exhibit a large amount of variation in terms of affected anatomic location, background objects, resolution, perspective and lighting. All images had adequate image quality to be deemed usable. Alongside images the dataset contains 25 pre-defined pieces of metadata information about the cases which include patient demographics, signs, symptoms and medical history. During the labelling process the dermatologists had access to all the captured images alongside all the metadata information.

In some example experiments according to the present disclosure, an information gain estimator model 114 was trained to determine whether to request one or more additional images. In some experimental conditions, an image type (near-shot or far-shot) was also selected. In the experiments, systems and methods of the present disclosure achieved a reduction of 27.86% of images requested compared to a clinician (3.15 vs. 4.37), at a reduction of 0.9 percent in top-3 accuracy (55.2 percent vs. 56.1 percent). When additionally selecting a near/far image type for the next image, systems and methods of the present disclosure achieved an additional reduction of 12.7% of images requested (2.79), at an additional reduction of 0.2 percent in top-3 accuracy (55.0%).

In further example experiments according to the present disclosure, a plurality of dummy inputs 106 was used to determine whether to request additional metadata input after an information gain estimator model 114 stopped requesting additional image inputs. In the experiment, provided systems requested less than one third of available metadata inputs, with a top-three accuracy reduction as low as 1.9 percent (63.1 percent accuracy using 4.37 images and 25 metadata inputs according to prior methods; 61.2 percent top-three accuracy using 3.15 images and 8 metadata inputs without using near-shot vs. far-shot instructions in additional image requests; and 59.5 percent using 2.79 images and 4 metadata inputs when using near-shot and far-shot instructions).

In simulated example experiments according to the present disclosure, results of the above-described example experiments were compared to a dataset showing user drop-out rates associated with real-world user interactions with an AI dermatology system (e.g., percentage of users dropping out without submitting a second input image, third input image, etc.). Based on the dataset and the results described above, systems and methods of the present disclosure can be expected to lead to an estimated 1.5 percent reduction in user drop-off rates (3.1 percent vs. 4.6 percent). Based on these expected outcomes, an expected number of accurate diagnoses can be computed by multiplying a diagnostic accuracy by a percentage of users expected to finish providing the requested inputs. In these simulated experiments, systems and methods of the present disclosure provided an increased number of positive outcomes (approximately 57.3 percent of users vs. approximately 56.6 percent when using all data).

### Example Methods

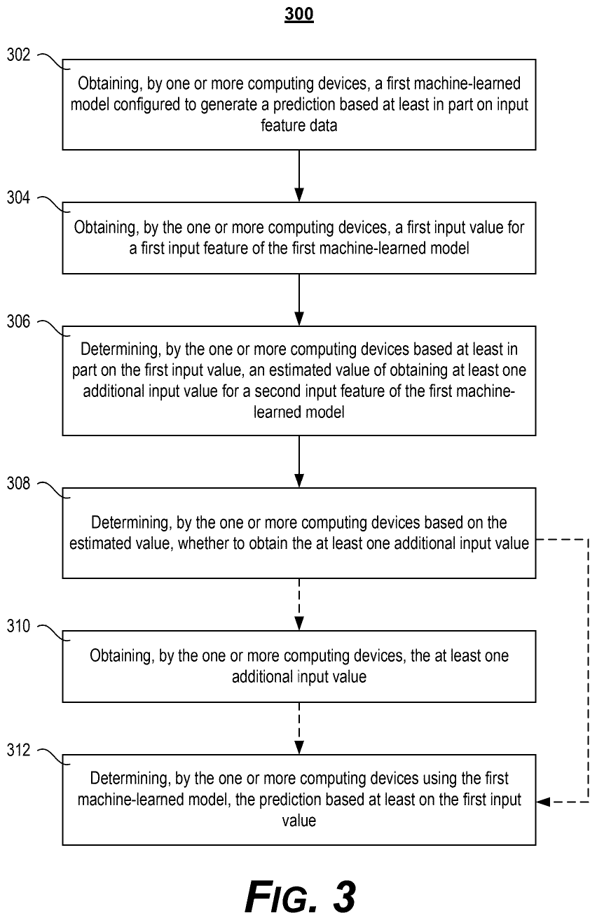

FIG. 3 depicts a flowchart diagram of an example method for active feature acquisition for multimodal image-based classification according to example embodiments of the present disclosure. Although FIG. 3 depicts steps performed in a particular order for purposes of illustration and discussion, the methods of the present disclosure are not limited to the particularly illustrated order or arrangement. The various steps of example method 300 can be omitted, rearranged, combined, and/or adapted in various ways without deviating from the scope of the present disclosure.

At 302, example method 300 can include obtaining, by one or more computing devices, a first machine-learned model configured to generate a prediction based at least in part on image data. In some instances, a first machine-learned model can be, comprise, or be comprised by a first machine-learned model 108. In some instances, the first machine-learned model can be a multimodal model configured for classification based in part on image data and based in part on non-image data. In some instances, the first machine-learned model can be a multimodal fusion model having a classifier head. In some instances, the classifier head can be a multilayer perceptron. In some instances, the first machine-learned model can be configured to be agnostic to a number of images used as input to the first machine-learned model. In some instances, the first machine-learned model can be configured to receive, as input, a pooled value associated with a plurality of image embeddings. In some instances, method 300 at 302 can include using one or more systems or performing one or more activities described with respect to FIG. 1.

At 304, example method 300 can include obtaining, by the one or more computing devices, a first input value for a first input feature of the first machine-learned model. In some instances, a first input value can be, comprise, or be comprised by a first input 102. In some instances, method 300 at 304 can include using one or more systems or performing one or more activities described with respect to FIG. 1.

At 306, example method 300 can include determining, by the one or more computing devices based at least in part on the input value, an estimated value of obtaining at least one additional input value for a second feature of the first machine-learned model. In some instances, an estimated value can be, comprise, or be comprised by an information gain estimate 116 or a value determined by an additional input value estimation 118.

In some instances, determining an estimated value can include obtaining, by the one or more computing devices, a plurality of possible additional input values for the second input feature; determining, by the one or more computing devices using the first machine-learned model, a plurality of respective predictions based on the first input value and based respectively on the plurality of possible additional input values; and determining, based on the plurality of respective predictions, an estimated value of obtaining the at least one additional input value for the first machine-learned model. In some instances, a respective prediction can be a classification output. In some instances, a classification output can include a plurality of class probabilities. In some instances, the plurality of possible additional input values can include possible categories associated with the second input feature, wherein the second input feature comprises a categorical input feature. In some instances, the second input feature can include a numerical input feature, and obtaining the plurality of possible additional input values can include obtaining a distribution of numerical values associated with the second input feature; and determining, based on the distribution of numerical values, a plurality of possible additional input values.

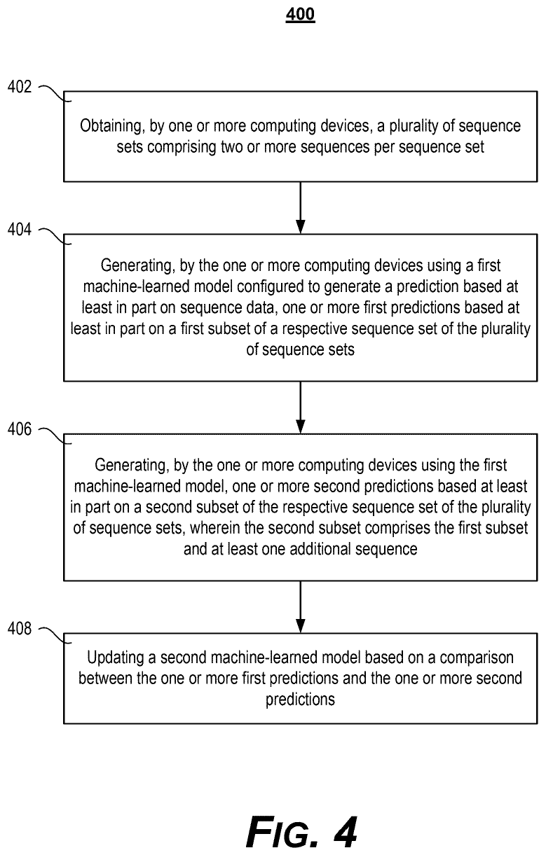

In some instances, determining an estimated value can include determining, using a second machine-learned model and based at least on the input value, an estimated value of obtaining the at least one additional input value for the second input feature of the first machine-learned model. In some instances, a second machine-learned model can be a model that was trained using one or more outputs of the first machine-learned model. In some instances, a second machine-learned model can be a model that was trained using one or more systems or one or more activities described with respect to FIG. 2 or 4.

In some instances, example method 300 can include obtaining, by the one or more computing devices, an information gain threshold associated with the second input feature, and the estimated value can be based at least in part on the information gain threshold. In some instances, example method 300 can include obtaining, by the one or more computing devices, a data collection burden associated with the second input feature; obtaining, by the one or more computing devices, a threshold indicative of a ratio of data collection burden to information gain; and determining, by the one or more computing devices, an estimated information gain associated with the second input feature. In some instances, the estimated value can be based at least in part on the estimated information gain, the data collection burden, and the threshold. In some instances, determining the estimated information gain can include determining a divergence metric between an output of the first machine-learned model generated without the at least one additional input value, and an output of the first machine-learned model generated using a possible additional input value associated with the second input feature. In some instances, the divergence metric can include at least one of a Kullback-Leibler divergence; a Jensen-Shannon divergence; and an absolute difference in predictive entropy.

In some instances, method 300 at 306 can include using one or more systems or performing one or more activities described with respect to FIG. 1.

At 308, example method 300 can include determining, by the one or more computing devices based on the estimated value, whether to obtain the at least one additional input value. In some instances, method 300 at 308 can include using one or more systems or performing one or more activities described with respect to FIG. 1.

At 310, example method 300 can include obtaining, by the one or more computing devices, the at least one additional input value. In some instances, obtaining the additional input value can include generating an additional input request 120. In some instances, the at least one additional input value can include image data. In some instances, image data can have an image type. In some instances, an image type can be associated with one or more machine-readable or human-readable instructions for obtaining an additional image. In some instances, the at least one additional input value can include non-image data. In some instances, method 300 at 310 can include using one or more systems or performing one or more activities described with respect to FIG. 1.

At 312, example method 300 can include determining, by the one or more computing devices using the first machine-learned model, the prediction based at least on the first input image. In some instances, the prediction can be, comprise, or be comprised by a prediction 110 or prediction 210. In some instances (e.g., instances where the at least one additional input is obtained at 310), the prediction can be determined based at least on the first input image and the at least one additional input. In some instances, the prediction can include one or more medical diagnoses. In some instances, method 300 at 312 can include using one or more systems or performing one or more activities described with respect to FIG. 1.

FIG. 4 depicts a flowchart diagram of an example method for training a machine-learned model for estimating a value of obtaining an additional input image according to example embodiments of the present disclosure. Although FIG. 4 depicts steps performed in a particular order for purposes of illustration and discussion, the methods of the present disclosure are not limited to the particularly illustrated order or arrangement. The various steps of example method 400 can be omitted, rearranged, combined, and/or adapted in various ways without deviating from the scope of the present disclosure.

At 402, example method 400 can include obtaining, by one or more computing devices, a plurality of sequence sets comprising two or more sequences per sequence set. In some instances, a sequence set can be, comprise, or be comprised by a training input set 202. In some instances, a sequence set can be, comprise, or be comprised by a set of images. In some instances, method 400 at 402 can include using one or more systems or performing one or more activities described with respect to FIG. 2.

At 404, example method 400 can include generating, by the one or more computing devices using a first machine-learned model configured to generate a prediction based at least in part on sequence data, one or more first predictions based at least in part on a first subset of a respective sequence set of the plurality of sequence sets. In some instances, a first machine-learned model can be, comprise, or be comprised by a first machine-learned model 108. In some instances, a first prediction can be, comprise, or be comprised by a prediction 210. In some instances, a first subset can be a training input subset 206. In some instances, the first predictions can be classification outputs. In some instances, the first predictions can include a plurality of probabilities (e.g., class probabilities, etc.). In some instances, method 400 at 404 can include using one or more systems or performing one or more activities described with respect to FIG. 2.

At 406, example method 400 can include generating, by the one or more computing devices using the first machine-learned model, one or more second predictions based at least in part on a second subset of the respective sequence set of the plurality of sequence sets, wherein the second subset comprises the first subset and at least one additional sequence. In some instances, a second prediction can be, comprise, or be comprised by a prediction 210. In some instances, the at least one additional sequence can be, comprise, or be comprised by an additional training input 208. In some instances, the at least one additional sequence can be an image characterized by an image type. In some instances, the image type can be associated with one or more human-readable instructions for obtaining an additional image. In some instances, method 400 at 406 can include using one or more systems or performing one or more activities described with respect to FIG. 2.

At 408, example method 400 can include updating a second machine-learned model based on a comparison between the one or more first predictions and the one or more second predictions. In some instances, a comparison can be, comprise, or be comprised by an information gain determination 212. In some instances, the second machine-learned model can be an information gain estimator model 114. In some instances, the second machine-learned model can be a statistical regression model. In some instances, the second machine-learned model can be a random forest regressor. In some instances, method 400 at 408 can include using one or more systems or performing one or more activities described with respect to FIG. 2.

FIG. 5 depicts a flowchart of a method 500 for training one or more machine-learned models according to aspects of the present disclosure. For instance, an example machine-learned model can include a first machine-learned model 108 or information gain estimator model 114.

One or more portion(s) of example method 500 can be implemented by a computing system that includes one or more computing devices such as, for example, computing systems described with reference to the other figures. Each respective portion of example method 500 can be performed by any (or any combination) of one or more computing devices. Moreover, one or more portion(s) of example method 500 can be implemented on the hardware components of the device(s) described herein, for example, to train one or more systems or models. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5 is described with reference to elements/terms described with respect to other systems and figures for exemplary illustrated purposes and is not meant to be limiting. One or more portions of example method 500 can be performed additionally, or alternatively, by other systems.

At 502, example method 500 can include obtaining a training instance. A set of training data can include a plurality of training instances divided between multiple datasets (e.g., a training dataset, a validation dataset, or testing dataset). A training instance can be labeled or unlabeled. Although referred to in example method 500 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 504, example method 500 can include processing, using one or more machine-learned models, the training instance to generate an output. The output can be directly obtained from the one or more machine-learned models or can be a downstream result of a chain of processing operations that includes an output of the one or more machine-learned models.

At 506, example method 500 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 508, example method 500 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 500 can include implementing a number of generalization techniques (e.g., weight decays, dropouts, etc.) to improve the generalization capability of the models being trained.

In some implementations, example method 500 can be implemented for training a machine-learned model from an initialized state to a fully trained state (e.g., when the model exhibits a desired performance profile, such as based on accuracy, precision, recall, etc.).

In some implementations, example method 500 can be implemented for particular stages of a training procedure. For instance, in some implementations, example method 500 can be implemented for pre-training a machine-learned model. Pre-training can include, for instance, large-scale training over potentially noisy data to achieve a broad base of performance levels across a variety of tasks/data types. In some implementations, example method 500 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

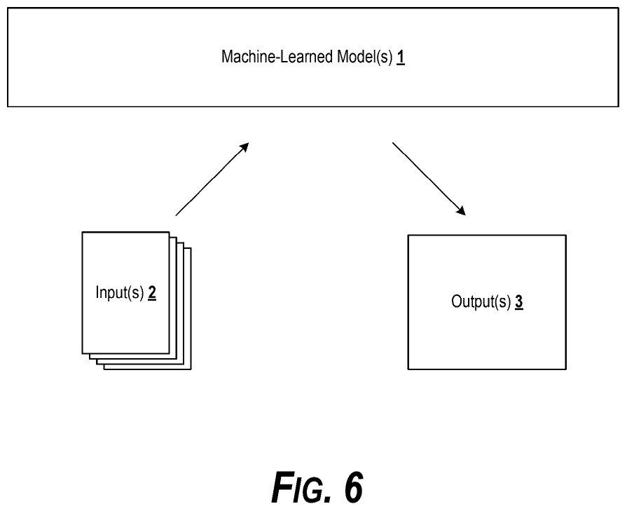

FIG. 6 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Model Development Platform

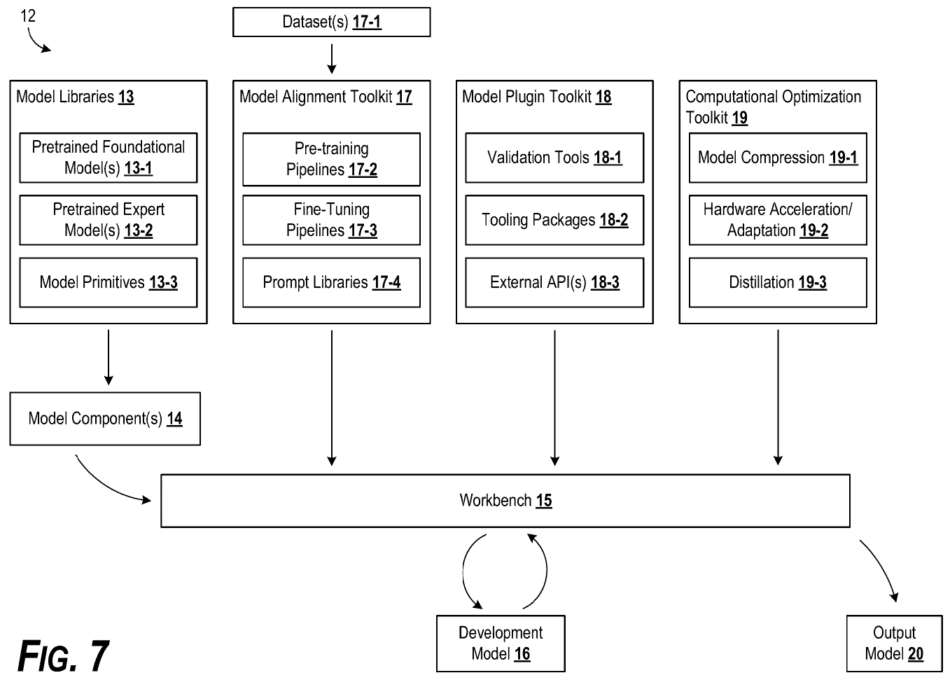

FIG. 7 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 500 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

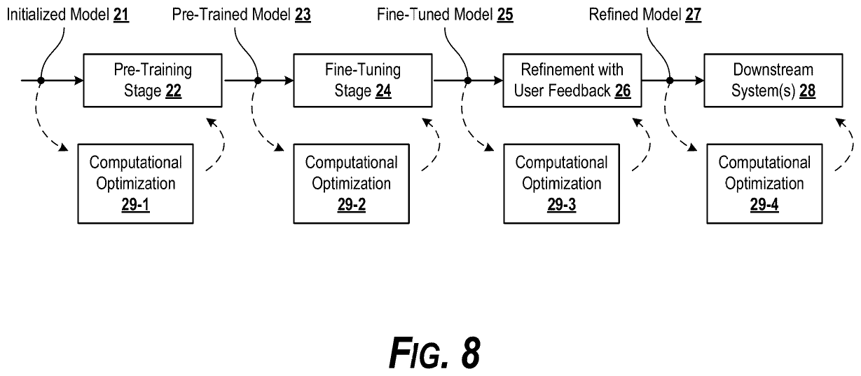

FIG. 8 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

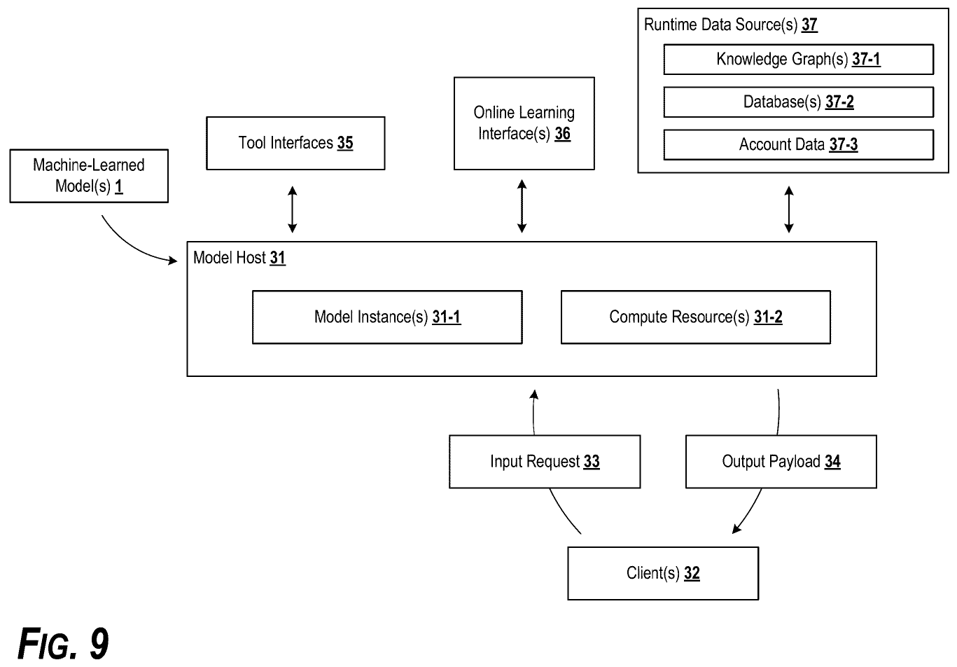

FIG. 9 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

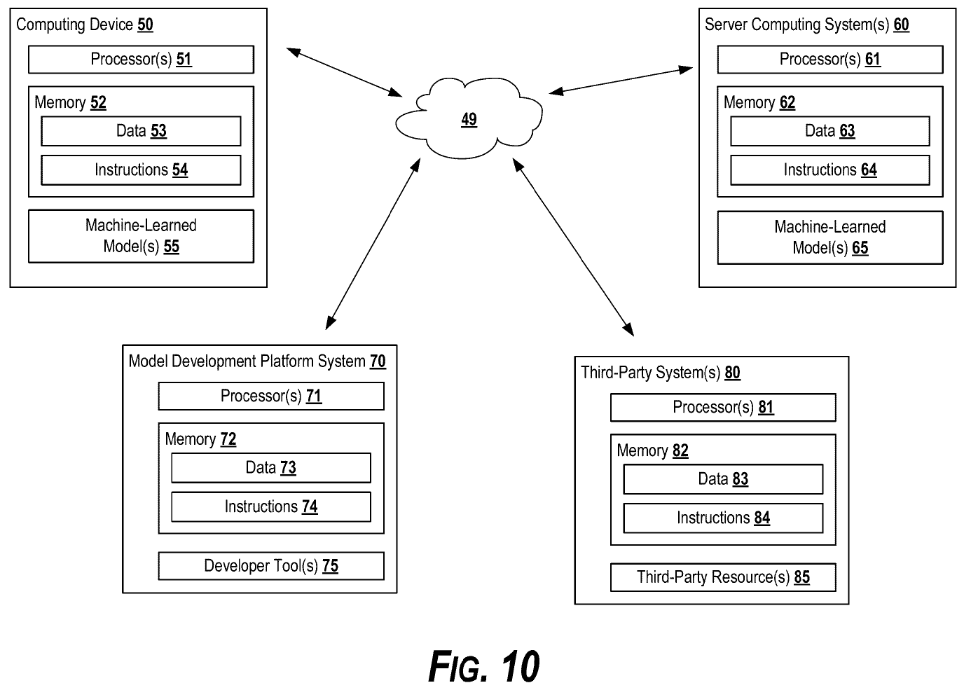

FIG. 10 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 10 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 10 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

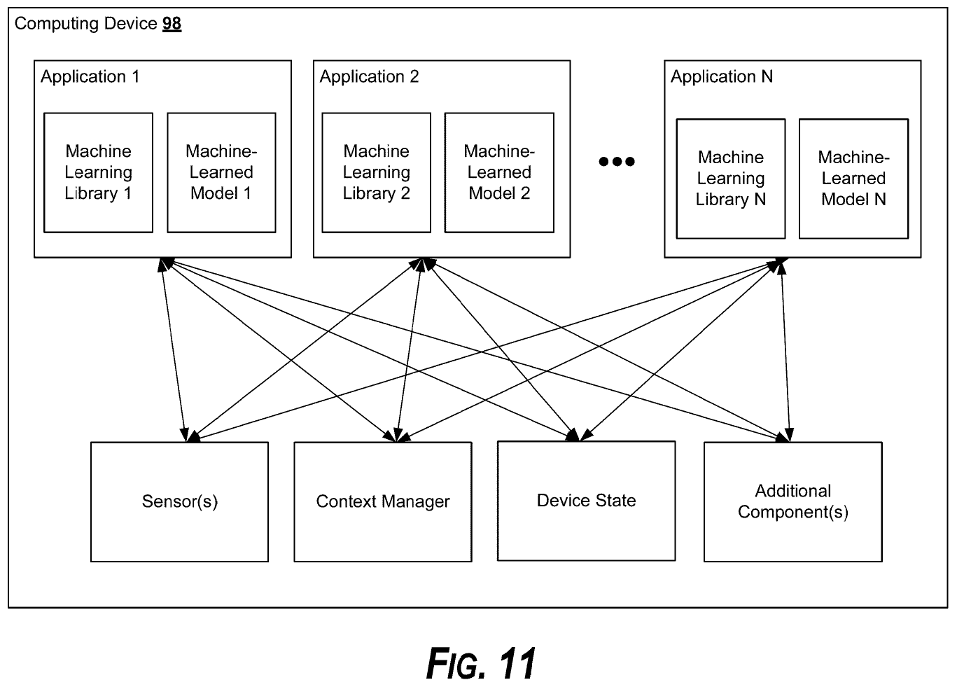

FIG. 11 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 11, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

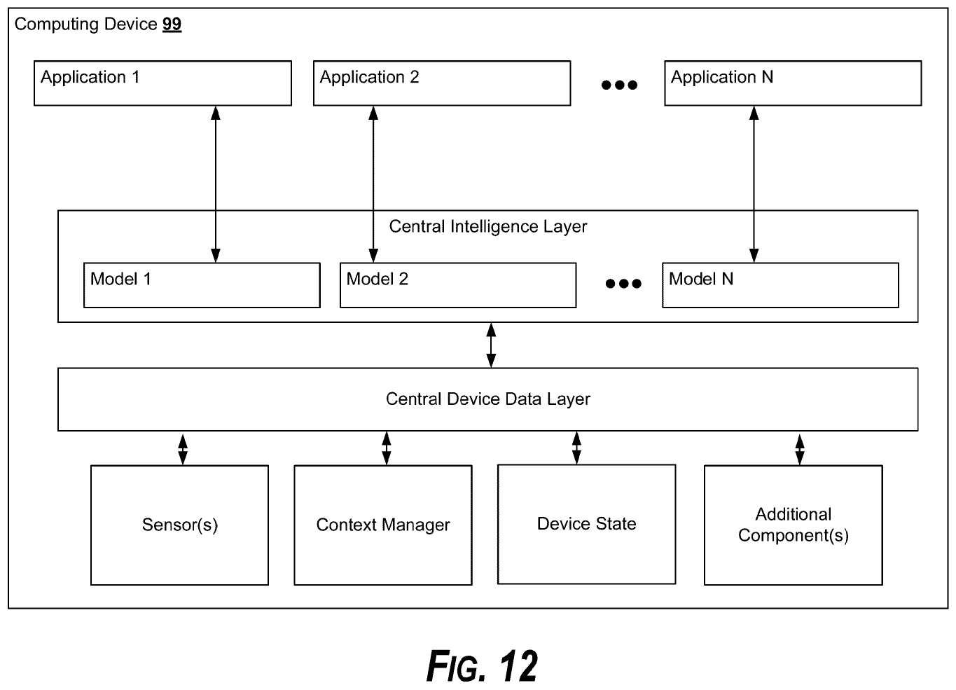

FIG. 12 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 12, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 12, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for active feature acquisition for machine learning models, comprising:
obtaining, by one or more computing devices, a first machine-learned model configured to generate a prediction based at least in part on input feature data;
obtaining, by the one or more computing devices, a first input value for a first input feature of the first machine-learned model;
determining, by the one or more computing devices based at least in part on the first input value, an estimated value of obtaining at least one additional input value for a second input feature of the first machine-learned model;
determining, by the one or more computing devices based on the estimated value, whether to obtain the at least one additional input value; and
determining, by the one or more computing devices using the first machine-learned model, the prediction based at least in part on the first input value.

2. The computer-implemented method of claim 1, wherein:
determining, by the one or more computing devices based at least in part on the first input value, the estimated value of obtaining at least one additional input value for the second input feature of the first machine-learned model comprises:
determining, by the one or more computing devices based at least in part on the first input value, a plurality of estimated values of obtaining at least one additional input value respectively for a plurality of different input features of the first machine-learned model; and
the method further comprises:
selecting, by the one or more computing devices, a selected input feature of the plurality of different input features based on the plurality of estimated values;
obtaining, by the one or more computing devices, the at least one additional input value for the selected input feature; and
wherein the prediction is determined based at least on the first input value and the at least one additional input value for the selected input feature.

3. The method of claim 1, wherein determining an estimated value comprises:
obtaining, by the one or more computing devices, a plurality of possible additional input values for the second input feature;
determining, by the one or more computing devices using the first machine-learned model, a plurality of respective predictions based on the first input value and based respectively on the plurality of possible additional input values; and
determining, based on the plurality of respective predictions, an estimated value of obtaining the at least one additional input value for the second input feature of the first machine-learned model;
wherein a respective prediction comprises a plurality of probabilities.

4. The method of claim 3, wherein the second input feature comprises a categorical input feature, and the plurality of possible additional input values comprises possible categories associated with the second input feature.

5. The method of claim 3, wherein the second input feature comprises a numerical input feature, and obtaining the plurality of possible additional input values comprises:
obtaining a distribution of numerical values associated with the second input feature; and determining, based on the distribution of numerical values, a plurality of possible additional input values.

6. The method of claim 1, wherein determining an estimated value comprises determining, using a second machine-learned model and based at least on the first input value, an estimated value of obtaining the at least one additional input value for the second input feature of the first machine-learned model.

7. The method of claim 6, wherein the second machine-learned model was trained by:
obtaining a plurality of sequence sets comprising two or more sequences per sequence set;
generating, using the first machine-learned model, one or more first outputs based at least in part on a first subset of a sequence image set of the plurality of sequence sets;
generating, using the first machine-learned model, one or more second outputs based at least in part on a second subset of the respective sequence set of the plurality of sequence sets, wherein the second subset comprises the first subset and at least one additional sequence; and
updating a second machine-learned model based on a comparison between the one or more first outputs and the one or more second outputs.

8. The method of claim 1, further comprising:
obtaining, by the one or more computing devices, an information gain threshold associated with the second input feature;
wherein the estimated value is based at least in part on the information gain threshold.

9. The method of claim 1, further comprising:
obtaining, by the one or more computing devices, a data collection burden associated with the second input feature;
obtaining, by the one or more computing devices, a threshold indicative of a ratio of data collection burden to information gain; and
determining, by the one or more computing devices, an estimated information gain associated with the second input feature;
wherein the estimated value is based at least in part on the estimated information gain, the data collection burden, and the threshold.

10. The method of claim 9, wherein determining the estimated information gain comprises determining a divergence metric between an output of the first machine-learned model generated without the at least one additional input value, and an output of the first machine-learned model generated using a possible additional input value associated with the second input feature.

11. The method of claim 10, wherein the divergence metric comprises at least one of:
a Kullback-Leibler divergence;
a Jensen-Shannon divergence; and
an absolute difference in predictive entropy.

12. The method of claim 1, wherein the first machine-learned model is a multimodal model configured for classification based in part on image data and based in part on non-image data.

13. The method of claim 12, wherein the first machine-learned model is configured to be agnostic to a number of images used as input to the first machine-learned model, and wherein the first machine-learned model is configured to receive, as input, a pooled value associated with a plurality of image embeddings.

14. The method of claim 1, wherein the prediction comprises one or more medical diagnoses.

15. A computer-implemented method for training a machine-learned model for estimating a value of obtaining an additional input sequence, comprising:
obtaining, by one or more computing devices, a plurality of sequence sets comprising two or more sequences per sequence set;
generating, by the one or more computing devices using a first machine-learned model configured to generate a prediction based at least in part on sequence data, one or more first predictions based at least in part on a first subset of a respective sequence set of the plurality of sequence sets;
generating, by the one or more computing devices using the first machine-learned model, one or more second predictions based at least in part on a second subset of the respective sequence set of the plurality of sequence sets, wherein the second subset comprises the first subset and at least one additional sequence; and
updating a second machine-learned model based on a comparison between the one or more first predictions and the one or more second predictions.

16. The method of claim 15, wherein the plurality of sequence sets comprises a plurality of image sets.

17. The method of claim 15, wherein a first prediction comprises a plurality of class probabilities.

18. The method of claim 15, wherein the second machine-learned model is a statistical regression model.

19. The method of claim 18, wherein the second machine-learned model is a random forest regressor.

20. One or more non-transitory computer-readable media storing instructions that are executable by a computing system to perform operations, the operations comprising:
obtaining a first machine-learned model configured to generate a prediction based at least in part on input feature data;
obtaining a first input value for a first input feature of the first machine-learned model;
determining, based at least in part on the first input value, an estimated value of obtaining at least one additional input value for a second input feature of the first machine-learned model;
determining, based on the estimated value, whether to obtain the at least one additional input value; and
determining, using the first machine-learned model, the prediction based at least in part on the first input value.
